(19) United States
(12) Patent Application Publication
(10) Pub. No.: US 2011/0020518 A1
(43) Pub. Date: Jan. 27, 2011

(54) TASTE MODIFYING PRODUCT

(76) Inventors: Estelle Delort, Versoix (CH); Eric Frerot, Ville-La-Grand (FR); Alain Jaquier, Commugny (CH); Mark Rubin, Thoiry (FR); Alain Velluz, Arenthon (FR); Robert Wagner, Gex (FR)

Correspondence Address: WINSTON & STRAWN LLP;PATENT DEPARTMENT, 1700 K STREET, N.W., WASHINGTON, DC, 20006, US

(21) Appl. No.: 12/933,923

(22) PCT Filed: Mar. 23, 2009
(86) PCT No.: PCT/IB09/51199

§ 371 Date: Sep. 22, 2010

(30) Foreign Application Priority Data
Apr. 4, 2008 (IB) PCT/IB2008/051258

(51) Int. Cl. A23L 1/226

(52) U.S. Cl. 426/537; 426/442

(57) ABSTRACT

The present invention relates to the use of alkylpyridines of formula (I) wherein R represents a C₆ to C₁₀ alkyl or alkenyl group as taste-conferring or enhancing ingredients to impart or reinforce the kokumi or umami taste in flavored compositions or flavored foods.

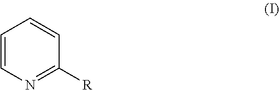

### TECHNICAL FIELD

The present invention relates to the field of taste. More particularly, it concerns the use of certain alkylpyridines as taste-enhancing ingredients to impart or reinforce the tastes known as kokumi or umami.

The present invention also concerns compositions or articles containing at least one of the aforementioned compounds.

### BACKGROUND AND PRIOR ART

Various alkylpyridines are known in the art for imparting fatty, fishy or metallic notes.

U.S. Pat. No. 5,298,486 (to Firmenich) discloses in column 2 lines 24 to 33 that 3-hexylpyridine is fruity and 3-heptylpyridine is fatty, metallic and fishy.

3-hexyl-, 3-heptyl- and 3-octylpyridine have been reported 1992 by Thomas and Bassols (J. Agric. Food Chem. 1992, 40, 2236-2243) from Firmenich. Their synthesis as aroma ingredients is disclosed in EP-A-470391.

U.S. Pat. No. 4,005,227 (to Firmenich) refers to mixtures of alkylpyridines for flavor enhancement. The alkyl groups identified are methyl, ethyl, propyl, butyl and phenyl.

U.S. Pat. No. 3,669,908 and U.S. Pat. No. 3,716,543 (both to IFF) also disclose that alkylpyridines deliver fishy notes. The compounds mentioned are very different from those used in the present invention.

However, none of these documents anticipate, report or suggest that the compounds described therein have organoleptic properties that can be used to impart or reinforce a kokumi or umami taste.

In New Developments in Umami (Enhancing) Molecules, Winkel et al, Chemistry & Biodiversity, Vol 5 (2008), p 1195-1203, a review of known umami modifying compounds is given. However, there is no suggestion of the compounds of the present invention.

Kokumi and umami are now established descriptors in the field of taste and are known to supplement, enhance, or modify the taste and/or aroma of a food without necessarily having a strong characteristic taste or aroma of their own. A desire for kokumi and umami exists for a wide range of foods including soups, sauces, savoury snacks, prepared meals, and condiments. Moreover, they are often found to complement or enhance foodstuffs which have a salty characteristic and, as a result, may be useful where sodium or salt reduction is desired.

Umami is one of the five basic tastes sensed by specialized receptor cells present on the human tongue. Umami applies to the sensation of savoriness, and particularly to the detection of glutamates, which are common in meats, cheese and other protein-rich foods. The behaviour of umami receptors explains why foods containing monosodium glutamate (MSG) often taste “fuller”. However, some consumers are apparently sensitive to MSG and may suffer from headaches or other illnesses upon consuming it. Thus replacement of MSG, at least partially, can be desirable.

Kokumi has been described variously as “deliciousness”, “continuity”, “mouthfulness”, “mouthfeel” and “thickness”. It exists naturally in a variety of foods such as cheese, giving a ‘mature’ cheese taste; vegetable flavors, particularly tomato; meat, where it gives a fullness and longer lasting taste; mayonnaise & dressings, where it can round out acid notes; fat-reduced food products, where it gives a similar fullness to full-fat products; herbs and spice; and soups, especially miso soup.

It would be desirable to provide a flavor or taste enhancing ingredient that has umami or kokumi characteristics. It would be even more desirable to provide a flavor or taste enhancing ingredient that has umami and kokumi characteristics.

### DESCRIPTION OF THE INVENTION

We have now surprisingly discovered that a certain class of pyridine derivatives can be used as flavor or taste enhancing ingredients, for instance to impart or reinforce the kokumi or umami taste of a flavoring composition or of a flavored food.

Accordingly, the present invention provides the use of a compound of formula (I),

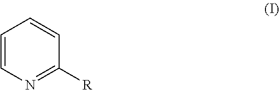

wherein R represents a C₆ to C₁₀ alkyl or alkenyl group as flavoring ingredient to confer, enhance, improve or modify the kokumi or umami taste of a flavored article.

Where R is greater than C₁₀, it is found that there is no umami or kokumi taste perceived. Similarly where R is less than C₆, there is no umami or kokumi taste perceived or, if there is any umami or kokumi taste, undesirable additional flavours can also be perceived. Thus, one advantage of the present invention is that the compounds confer umami and/or kokumi taste to a product without detrimentally affecting the flavor profile of the product.

Preferably R represents a C₆ to C₉ alkyl or alkenyl group, since the umami/kokumi taste is most noticeable in this range.

Preferably the compound is selected from the group consisting of 2-hexylpyridine, 2-heptylpyridine and 2-octylpyridine.

In yet a more preferred embodiment, a mixture of compounds according to formula (I) are provided together. Particularly preferred are mixtures of compounds in which there are at least two compounds selected from C₆ alkyl or alkenylpyridines, C₇ alkyl or alkenylpyridines and C₈ alkyl or alkenylpyridines. Most preferably a mixture of 2-hexylpyridine and 2-heptylpyridine are used since this provides a strong kokumi or umami taste at exceptionally low levels.

In a further aspect, the invention provides a flavoring composition comprising, as a kokumi or umami taste-conferring component, a compound of formula (I),

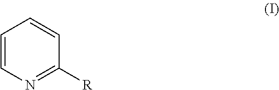

wherein R represents a C₆ to C₁₀ alkyl or alkenyl group.

In yet another aspect, the invention provides a flavored article comprising:
i) at least one compound of formula (I), or a flavoring composition as defined above; and
ii) a foodstuff base.

Particularly preferred foodstuffs for use with the compound of formula (I) include savory cubes, instant soups, canned soups, preserved meats, instant noodles, frozen dishes or preparations, sauces, flavored oils and spreads, snacks or biscuits.

As mentioned above, the invention concerns the use of a compound of formula (I) as a taste-conferring or enhancing ingredient, and in particular to impart or reinforce kokumi or umami taste. According to a particular embodiment of the invention, such use is very much appreciated by flavorists to impart or enhance the kokumi or umami taste in savoury flavors, such as beef, chicken, pork, and seafood. Surprisingly, in seafood applications such as surimi, or seafood bouillons or snack flavors, compounds according to formula (I) are also found to enhance the perception of sweetness and longevity of the flavor. By contrast, in beef flavors, the compounds according to formula (I) are found to enhance perception of fattiness and tallow notes.

In other words the present invention concerns a method to confer, enhance, improve or modify the taste properties, as indicated above, of a flavoring composition or of a flavored article, which method comprises adding to said composition or article an effective amount of at least a compound of formula (I). In the context of the present invention “use of a compound of formula (I)” includes the use of any composition containing compound (I) and which can be advantageously employed in the flavor industry as active ingredient.

In another aspect, the invention provides a taste-modifying composition comprising:
i) as taste-conferring or modifying ingredient, at least one compound according to formula (I) above;
ii) at least one ingredient selected from the group consisting of a flavor carrier and a flavor base; and
iii) optionally at least one flavor adjuvant.

By “flavor carrier” we mean here a material which is substantially neutral from a flavor point of view, insofar as it does not significantly alter the organoleptic properties of flavoring ingredients. The carrier may be a liquid or a solid.

Suitable liquid carriers include, for instance, an emulsifying system, i.e. a solvent and a surfactant system, or a solvent commonly used in flavors. A detailed description of the nature and type of solvents commonly used in flavor cannot be exhaustive. Suitable solvents include, for instance, propylene glycol, triacetine, triethyl citrate, benzylic alcohol, ethanol, vegetable oils or terpenes.

Suitable solid carriers include, for instance, absorbing gums or polymers, or even encapsulating materials. Examples of such materials may comprise wall-forming and plasticizing materials, such as mono, di- or trisaccharides, natural or modified starches, hydrocolloids, cellulose derivatives, polyvinyl acetates, polyvinylalcohols, proteins or pectins, or yet the materials cited in reference texts such as H. Scherz, Hydrokolloids: Stabilisatoren, Dickungs- and Gehermittel in Lebensmittel, Band 2 der Schriftenreihe Lebensmittelchemie, Lebensmittelqualität, Behr's VerlagGmbH & Co., Hamburg, 1996. Encapsulation is a well known process to a person skilled in the art, and may be performed, for instance, using techniques such as spray-drying, agglomeration, extrusion, coacervation and the like.

By “flavor base” we mean here a composition comprising at least one flavoring ingredient.

Said flavoring ingredient is not a compound of formula (I). Moreover, by “flavoring ingredient” it is meant here a compound, which is used in flavoring preparations or compositions to impart a hedonic effect. In other words such an ingredient, to be considered as being a flavoring one, must be recognized by a person skilled in the art as being able to impart or modify in a positive or pleasant way the taste of a composition, and not just as having a taste.

The nature and type of the flavoring co-ingredients present in the base do not warrant a more detailed description here, the skilled person being able to select them on the basis of its general knowledge and according to intended use or application and the desired organoleptic effect. In general terms, these flavoring co-ingredients belong to chemical classes as varied as alcohols, aldehydes, ketones, esters, ethers, acetates, nitriles, terpenoids, nitrogenous or sulphurous heterocyclic compounds and essential oils, and said perfuming co-ingredients can be of natural or synthetic origin. Many of these co-ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of flavor. It is also understood that said co-ingredients may also be compounds known to release in a controlled manner various types of flavoring compounds.

However, according to a particular embodiment of the invention, said flavor base advantageously comprises at least a compound of formula

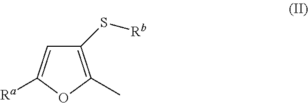

wherein R^{a} represents a hydrogen atom or a methyl group, and R^{b} represents a methyl or ethyl group, an acetyl group, or a C₃-C₁₀ group comprising a carbonyl group. These compounds are known to impart meaty notes in flavors.

In a particular embodiment R^{b} is a group such as methyl, acetyl, 2-furan-carbonyl, 1-methyl-3-oxo-butyl, 1-methyl-3-oxo-propyl, 1-ethyl-3-oxo-propyl, 1-propyl-3-oxo-propyl, 1,1-dimethyl-3-oxo-propyl, 1-pentyl-5-oxo-pent-3-enyl. In a particular embodiment R^{a} is a hydrogen atom.

Non-limiting examples of compounds (II) are S-(2-5-dimethyl-3-furyl) 2-furancarbothionate, S-(2-methyl-3-furyl)ethanethionate, 3-[(2-methyl-3-furyl)thio]butanal or 2-methyl-3-(methylthio)furan.

Therefore a flavoring composition comprising at least a compound of formula (I) and at least a compound of formula (II) is also an object of the present invention.

By “flavor adjuvant” we mean here an ingredient capable of imparting additional added benefit such as a color, a particular light resistance, chemical stability, and so on. A detailed description of the nature and type of adjuvant commonly used in flavoring bases cannot be exhaustive. Nevertheless, such adjuvants are well known to a person skilled in the art, but it has to be mentioned that said ingredients are well known to a person skilled in the art.

A composition consisting of at least one compound of formula (I) and at least one flavor carrier represents a particular embodiment of the invention as well as a flavoring composition comprising at least one compound of formula (I), at least one flavor carrier, at least one flavor base, and optionally at least one flavor adjuvant.

In a highly preferred embodiment, more than one compound of formula (I) is used in combination since it is found that a synergistic enhancement of the kokumi or umami taste can be achieved in this way. Moreover, it is found that the combination of ingredients can provide the desired kokumi or umami taste without imparting undesirable flavor notes.

For instance mixtures of 2-hexylpyridine with 2-heptylpyridine and/or 2-octylpyridine are found to be particularly effective at delivering kokumi or umami taste without adversely affecting the flavor.

Moreover, a compound of formula (I) can be advantageously incorporated into flavored articles to positively impart, or modify, the kokumi or umami taste of said articles. Thus, in yet another aspect, the present invention provides a flavored article comprising:
i) as taste-conferring or modifying ingredient, at least one compound of formula (I), as defined above, optionally present as part of a flavoring composition; and
ii) a foodstuff base.

Suitable foodstuff bases, e.g. foods or beverages, include savory cubes, instant soup, canned soups, preserved meat, instant noodles, frozen dishes and preparations, sauces in all forms, flavored oils and spreads, battered fried products, snacks and biscuits. Particularly preferred foodstuffs in which the compound according to formula (I) finds utility include those where topnotes such as seafood, beef, chicken, vegetables, cheese, fat, tallow and/or marrow are important.

For the sake of clarity, it has to be mentioned that, by “foodstuff” we mean here an edible product, e.g. a food or a beverage. Therefore, a flavored article according to the invention comprises one or more compounds according to formula (I), as well as optional benefit agents, corresponding to taste and flavor profile of the desired edible product, e.g. a savory cube.

The nature and type of the constituents of the foodstuffs or beverages do not warrant a more detailed description here, the skilled person being able to select them on the basis of his general knowledge and according to the nature of said product.

The proportions in which the compounds according to the invention can be incorporated into the various aforementioned articles or compositions vary within a wide range of values. These values are dependent on the nature of the article to be flavored and on the desired organoleptic effect as well as the nature of the co-ingredients in a given base when the compounds according to the invention are mixed with flavoring co-ingredients, solvents or additives commonly used in the art.

In the case of flavoring compositions, typical concentrations are in the order of 3 ppm to 50 ppm, more preferably 5 ppm to 75 ppm, most preferably 8 to 50 ppm of the compounds of the invention based on the weight of the consumer product into which they are incorporated. Concentrations lower than these, such as in the order of 0.001% to 0.5% by weight, can be used when these compounds are incorporated into flavored articles, the percentage being relative to the weight of the article.

At these levels the taste is typically described as umami-like, lasting, sweet and lingering.

### EXAMPLES

The invention will now be described in further detail by way of the following example, wherein the abbreviations have the usual meaning in the art, the NMR spectral data were recorded in CDCl₃, with a 400 MHz machine for ¹³C, the chemical displacements, δ, are indicated in ppm with respect to TMS as standard, and the coupling constants, J, are expressed in Hz.

### Example 1

### Preparation of 2-heptylpyridine

2-heptylpyridine was prepared as follows. In a 200 ml flask equipped with a CO₂/acetone condenser with a tube containing KOH and an introduction funnel, NH₃ (100 ml) was condensed. Under vigorous stirring ferric nitrate (0.15 g) was added. At about −35° C., sodium (3.61 g) was introduced gradually over a period of 30 minutes. Following this, 2-picoline (12.62 g) was added dropwise over 10 minutes. The mixture was stirred for a further 20 minutes and then 1-bromohexane (24.76 g) was added dropwise over 30 minutes. The mixture was stirred for a further 5 minutes after which it was left overnight to allow the ammonia to evaporate. Ice was added and the mixture extracted three times with ether. The organic phase was washed twice with brine, dried over magnesium sulphate, following which the solvent was removed. The residue was distilled at about 120° C. This yielded pure 2-heptylpyridine (16.82 g), characterized as follows:

¹³C-NMR: 162.6 (s); 149.2 (d); 136.2 (d); 122.7 (d); 120.8 (d); 38.5 (t); 31.8 (t); 30.0 (t); 29.4 (t); 29.2 (t); 22.7 (t); 14.1 (q)

### Example 2

### Preparation of 2-octylpyridine

2-octylpyridine was prepared in an identical manner to 2-heptylpyridine except that 1-bromoheptane was used instead of 1-bromohexane. It was characterized as follows:

¹³C-NMR: 162.6 (s); 149.2 (d); 136.2 (d); 122.7 (d); 120.8 (d); 38.5 (t); 31.9 (t); 30.0 (t); 29.5 (t); 29.4 (t); 29.3 (t); 22.7 (t); 14.1 (q).

### Example 3

### Preparation of 2-nonylpyridine

2-nonylpyridine was prepared in an identical manner to 2-heptylpyridine except that 1-bromooctane was used instead of 1-bromohexane. It was characterized as follows:

¹³C-NMR: 162.6 (s); 149.2 (d); 136.1 (d); 122.7 (d); 120.8 (d); 38.5 (t); 31.9 (t); 29.9 (t); 29.6 (t); 29.4 (t); 29.5 (t); 29.3 (t); 22.7 (t); 14.1 (q).

### Example 4

### Preparation of 2-undecylpyridine

2-undecylpyridine was prepared in an identical manner to 2-heptylpyridine except that 1-bromodecane was used instead of 1-bromohexane. It was characterized as follows:

¹³C-NMR: 162.6 (s); 149.2 (d); 136.1 (d); 122.7 (d); 120.8 (d); 38.5 (t); 31.9 (t); 29.9 (t); 29.67 (t); 29.60 (t); 29.5 (t); 29.4 (t); 29.5 (t); 29.3 (t); 22.7 (t); 14.1 (q).

### Example 5

### Preparation of 2-dodecylpyridine

2-dodecylpyridine was prepared in an identical manner to 2-heptylpyridine except that 1-undecane was used instead of 1-bromohexane. It was characterized as follows:

¹³C-NMR: 162.6 (s); 149.2 (d); 136.1 (d); 122.7 (d); 120.8 (d); 38.5 (t); 31.9 (t); 29.9 (t); 29.6 (t); 29.7 (t); 29.6 (t), 29.5 (t); 29.4 (t); 29.5 (t); 29.3 (t); 22.7 (t); 14.1 (q).

### Example 6

### Preparation of 4-methyl-2-pentylpyridine

4-methyl-2-pentylpyridine was prepared as follows:

2-bromo-4-methylpyridine (2 g) and THF (10 ml) were introduced into a reactor vessel under argon. The vessel was cooled to −78° C. and the Pd(dppf)₂Cl₂ catalyst (0.18 g) was added, followed by 3.0 M pentyl magnesium bromide (10 ml). The reaction was allowed to warm to 0° C. and continued until the starting material had been used up. The reaction was quenched with 20 ml of saturated ammonium chloride solution and extracted with 20 ml of ethyl acetate. The ethyl acetate layer was extracted with 20 ml of 1 M aqueous hydrochloric acid. The aqueous acid layer was neutralized with 1 M NaOH and extracted with 20 ml of ethyl acetate. The ethyl acetate layer was washed with brine and dried on anhydrous sodium sulphate. The product phase was filtered and concentrated on the rotary evaporator to give 850 mg of product, a 44.9% yield.

### Example 7

### Evaluation of Alkylpyridines

Alkylpyridines shown in the following table were prepared by firstly being diluted into propylene glycol solvent in order to provide a 10% solution of the alkylpyridine. Each solution was then diluted using a 0.3% aqueous solution of NaCl, heated if necessary to achieve better dissolution, to a concentration of between 10 ppm and 30 ppm of the alkylpyridine. The concentrations are given in the table below. The samples were then stored at ambient temperature.

A panel consisting of 8 trained panelists evaluated the samples for taste properties on a scale of 0 to 10 where 0 denoted no kokumi/umami effect and 10 denoted extremely strong kokumi/umami effect.

TABLE 1

| | | | Kokumi/Umami taste |
|---|---|---|---|
| Compound | ppm | Description | intensity* |
| Pyridine (1) | 30 | Sweet, plastic, chemical, slightly amine, | 0 |
| | | dirty, wet wood, roast | |
| 2-picoline (2) | 20 | Chemical, hot plastic, polystyrene, | 0 |
| | | green, rubbery, dirty | |
| 2-Ethylpyridine (3) | 10 | Plastic, slightly amine, green, rubbery, | 0 |
| | | woody, dirty | |
| 2-Propylpyridine (4) | 10 | Plastic, slightly fruity, green, vegetal, | 0 |
| | | fatty, solvent, wood, pyridine, garbage | |
| Compound of ex. 6 | 10 | Fruity, woody, strong | 0 |
| 2-Hexylpyridine (5) | 10 | Fruity, fatty, oily, green, bell pepper | 7 |
| Compound of ex. 1 | 10 | Fruity, woody, blackcurrant, green, | 7 |
| | | weaker, raw, fatty | |
| Compound of ex. 2 | 10 | Fruity, bit rotten, weak, fatty, waxy, | 2 |
| | | oily, green, beany | |
| Compound of ex. 3 | 10 | Waxy, fatty, slightly fruity, slightly | 1 |
| | | soapy | |
| Compound of ex. 4 | 10 | Weak, fabric conditioner | 0 |
| Compound of ex. 5 | 10 | Slightly floral, very weak | 0 |

(1) order ref. 82703, Fluka
(2) order ref. 80221, Fluka
(3) ref. 150560050, Acros Organics
(4) product number P0336, TCI Europe
(5) item code A12772, Alfa Aesar

### Example 8

### Evaluation of Mixtures of Alkylpyridines

A taste conferring composition was prepared containing the following components:

TABLE 2

| Component | % by weight of total actives |
|---|---|
| 2-hexylpyridine | 50 |
| Compound of example 2 | 40 |
| Compound of example 3 | 10 |

The mixture was then diluted using propylene glycol to provide a 10% active solution of the ingredients.

### Example 9

### Shrimp Flavor Containing Alkylpyridine

A shrimp flavor mixture was prepared by admixing the following ingredients:

TABLE 3

| Ingredient | % by weight |
|---|---|
| 2-acetylpyrazine | 0.22 |
| Dimethysulphide | 1.30 |
| 4-methylphenol | 0.10 |
| Trimethylamine (40% aqueous solution) | 5.00 |
| Safranal | 0.10 |
| Propylene glycol | 93.30 |

The shrimp flavor mixture was then added to a 0.3% aqueous NaCl solution at 50° C. and stirred. The resulting mixture contained 0.07% by weight of the shrimp flavor, based on the total weight of the solution.

The solution was allowed to cool and then divided into two samples. The first sample contained only the shrimp flavor mixture. The second sample further contained 0.01% by weight of the flavor enhancing mixture according to example 8.

The samples were then tasted by a panel of 8 trained panelists. The first sample was found to be substantially devoid of umami/kokumi character whereas the second sample delivered a long-lasting, umami-like taste that complemented the shrimp flavor profile.

1.-9. (canceled)

10. A method to confer, enhance, improve or modify the kokumi or umami taste of a flavored edible article which comprises providing a compound of formula (I), 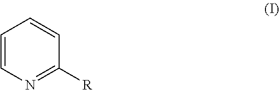
wherein R represents a C₆ to C₁₀ alkyl or alkenyl group as an ingredient of the article.

11. The method according to claim 10, wherein R represents a C₆ to C₈ alkyl or alkenyl group.

12. The method according to claim 10, wherein the compound is 2-hexylpyridine, 2-heptylpyridine or 2-octylpyridine.

13. The method according to claim 10, wherein a mixture of compounds according to formula (I) is provided in the article.

14. The method according to claim 13, wherein the mixture comprises at least two compounds selected from C₆ alkyl or alkenylpyridines, C₇ alkyl or alkenylpyridines and C₈ alkyl or alkenylpyridines.

15. A flavoring composition comprising a compound of formula (I), 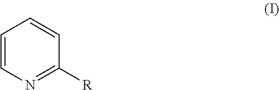
wherein R represents a C₆ to C₁₀ alkyl or alkenyl group, in an amount effective as a kokumi or umami taste-modifying component when added to an edible article.

16. A flavored edible article comprising:
at least one compound of formula (I), 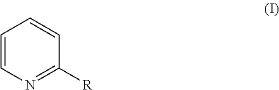
wherein R represents a C₆ to C₁₀ alkyl or alkenyl group; and
a foodstuff base.

17. The flavored article according to claim 16, wherein the foodstuff base is a savory cube, an instant soup, a canned soup, a preserved meat, instant noodles, a frozen dish or preparation, a sauce, flavored oils and spreads, a battered fried product, a snack or a biscuit.

18. A flavored edible article comprising:
a flavoring composition as defined in claim 15; and
a foodstuff base.

19. The flavored article according to claim 18, wherein the foodstuff base is a savory cube, an instant soup, a canned soup, a preserved meat, instant noodles, a frozen dish or preparation, a sauce, flavored oils and spreads, a battered fried product, a snack or a biscuit.

20. A taste-modifying composition comprising:
as a taste-modifying ingredient, at least one compound according to formula (I), 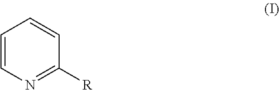
wherein R represents a C₆ to C₁₀ alkyl or alkenyl group;
at least one ingredient selected from the group consisting of a flavor carrier and a flavor base; and
optionally at least one flavor adjuvant.

21. A flavored edible article comprising:
a taste-modifying composition as defined in claim 19; and
a foodstuff base.

22. The flavored article according to claim 21, wherein the foodstuff base is a savory cube, an instant soup, a canned soup, a preserved meat, instant noodles, a frozen dish or preparation, a sauce, flavored oils and spreads, a battered fried product, a snack or a biscuit.
